(19) United States
(12) Patent Application Publication
(10) Pub. No.: US 2007/0190275 A1
(43) Pub. Date: Aug. 16, 2007

(54) Method for the production of a flexible tube

(76) Inventor: Achim Helmenstein, Engelskirchen (DE)

Correspondence Address: FULWIDER PATTON LEE & UTECHT, LLP, 200 OCEANGATE, SUITE 1550, LONG BEACH, CA, 90802, US

(21) Appl. No.: 10/565,321

(22) PCT Filed: Jul. 3, 2004
(86) PCT No.: PCT/EP04/07274

§ 371 Date: Jan. 16, 2007

(30) Foreign Application Priority Data
Jul. 22, 2003 (DE) 103 33 160.3

(51) Int. Cl. B29C 45/00

(52) U.S. Cl. 428/35.7; 264/320; 264/328.1; 264/338; 264/259

(57) ABSTRACT

Disclosed is a method for producing a tube comprising a compressible peripheral wall in an injection molding process by using an injection mold that is provided with a core and a female die. The opening end of the tube is produced in a neck mold which retains the unfinished tube also during opening of the mold. Special measures prevent the soft plastic of the unfinished tube from sticking to the mold.

The invention relates to a method for producing a flexible tube having a compressible peripheral wall, preferably of a soft and flexible plastic material (referred to herein as soft plastic), and in particular a tube for extruding plastic or liquid media.

It is known to produce tubes from plastic material. Here, the extrusion blow molding method may be used wherein the work piece is integrally made from plastic material in a blow mold. First, a plastically deformable plastic hose is extruded into a blow mold, whereupon air is pressed into the blow mold closed by the hose, whereby the plastic material contacts the mold wall, where it cools and solidifies. The most widespread way of producing tubes uses a method in which the desired lengths are cut from an extruded hose and are then connected to a tube neck member. This method requires relatively high efforts since the tube is made as two parts and the neck member and the hose are afterwards connected or joined by molding.

The extrusion blow molding method, however, has a lower yield per product and is considered less precise in the process and in reproducing the geometry of an article.

DE 4318014C1 (Fischbach) describes the production of cartridges for holding plastic masses. Such cartridges are made of a rigid cylindrical cartridge body containing a piston that is advanced to extrude the mass. Such cartridges are made of hard or more rigid plastic material (hereinafter referred to as hard plastic) and they are dimensionally stable since they have to maintain their cylindrical shape during use and while the mass is extruded.

It is an object of the invention to provide a method for producing a flexible tube that allows for a fast and economic production of tubes.

The object is achieved according to the invention with the features mentioned in claim 1. According thereto, the method for producing a tube of soft plastic comprises the following steps:
injection molding of an integral unfinished tube comprising a tube body, a tube shoulder and a tube opening, using a female die, a core and a neck mold,
demolding the unfinished tube by withdrawing the core while holding the unfinished tube at the neck mold, and retracting the female die,
releasing the unfinished tube from the neck mold,
flattening and closing the open end of the tube body.

The method of the invention allows to produce a tube as a single piece that is made integrally in one injection molding process. This method can be performed with a short cycle and allows to produce highly dimensionally stable tubes in a normal injection molding apparatus. The method is particularly suited for the mass production of tubes. The method is generally relates to methods as they are used for producing rigid cartridges and described, for example, in DE 43 18 014 C1 (Fischbach) and DE 197 03 316 A1 (Fischbach). However, a major difference between a method for producing tubes and a method for producing cartridges is that, after having been filled, the open end of the tube is flattened and closed, for example by welding. When producing rigid cartridges, these are closed by an additional piston after having been filled, which piston can be used as an extruder piston when the product is applied at a later time. Or the open end of the cartridge has to be closed with an additional lid or an additional membrane. Further, some method steps for making cartridges cannot be applied unmodified to the production of tubes since the soft plastic used for tubes has a strong tendency to adhere after being shaped in the injection mold. This causes the risk of sticking to the injection mold. Often, it is another property of soft plastic that the same follows the female die better than the hard plastic. This may be due to a reduced shrinking resulting from the lesser wall thickness or to the modified mold filling behavior. Further, the strength of the soft plastic in general is less than the strength of hard plastic. Together with the relatively thin wall thickness, this results in a relatively low overall strength of the tube upon demolding from the injection molding tool. Thus, special measures are necessary for withdrawing the female die and the core from the unfinished tube.

One possibility to reduce the tendency to adhere is to place a sheet or a sleeve formed therefrom between the core and the female die and to cause the same to contact the core or the female die. This sheet or sleeve forms the outer surface or the inner surface of the tube to be produced and is placed into the injection molding tool before the injection process. The sheet or the sleeve may also have particular sliding properties so that it will not adhere to the surface of the core or the female die. It is also conceivable to use sheets or sleeves having desired barrier properties with respect to gases or water vapor. Use may also be made of sheets or sleeves that have a better chemical resistance against the material filled into the tube. Moreover, it is also possible to use sheets or sleeves whose surface is already printed as with a label or has a decorative surface with structures or different materials such as cloths or textiles. Thus, surfaces with a desired grip can be made on the tube by providing such a sleeve or sheet with these properties. The sheet or sleeve may also cover only a part of the outer surface or the inner surface, or it may extend into the region of the tube shoulder.

Another measure to prevent the unfinished tube from sticking to the core is to provide the core with a blow line conducting air between the unfinished tube and the tube to facilitate demolding. Preferably, the air exits through a slot having a width so small that the liquid plastic material cannot enter the slot. It would also be possible to enlarge the air exit slot by a relative radial movement of a core segment. The air pressed out from the slot lifts the unfinished tube from the core and facilitates the withdrawal of the core upon demolding. It can be advantageous to start supplying air already after the end of the mold filling phase.

Another possibility to facilitate demolding is that a demolding bevel provided at the female die is made larger than a demolding bevel provided at the core. The larger the demolding bevel, the easier the corresponding mold part is withdrawn from the retained unfinished tube. By making the demolding bevel of the female die larger than the demolding bevel of the core, it is achieved that the female die can be withdrawn from the unfinished tube although the same still adheres strongly to the inner surface of the female die and only the tube neck is held at front by the jaws. The term demolding bevel is not necessarily limited to a bevel with a constant inclination. Rather, varying inclination profiles could also be provided. Generally, the demolding bevel is defined by the difference between the diameters across individual sections of the length of the female die and the core, respectively, up to both ends of the female die and the core, respectively. The greater this difference in diameter is per section of length, the larger the demolding bevel is.

Another possibility to prevent the plastic material from adhering to the injection mold is the use of a female die or a core bearing an adhesion-reducing slide coating.

The above mentioned method aids for improving the demoldability of tubes can also be combined with each other.

The method can be executed such that in a first injection phase the core or a part thereof is supported at the neck mold in a centering region between the annular shoulder and the tube outlet by conically centering webs, and that in a fill-up phase the core or a part thereof is held at a distance from the centering region so as to fill the portions kept free by the webs during the injection phase.

An alternative embodiment of the method provides that the injection molding is effected by injection to the annular tube outlet or the tube shoulder or through the tube threading. In this case, a two-stage method providing the forming of centering stages is not necessary. Rather, to produce tubes with an open outlet, the injection molding method can be executed in one injection step without relative movement of a centering core. However, it is also possible in this case to execute a two-stage method with a centering core, wherein the same is also held at a distance in the fill-up phase, so as to produce closed tubes.

The following is a detailed description of embodiments of the invention with reference to the drawings. This description should not be construed as limiting the scope of the claims.

In the Figures:

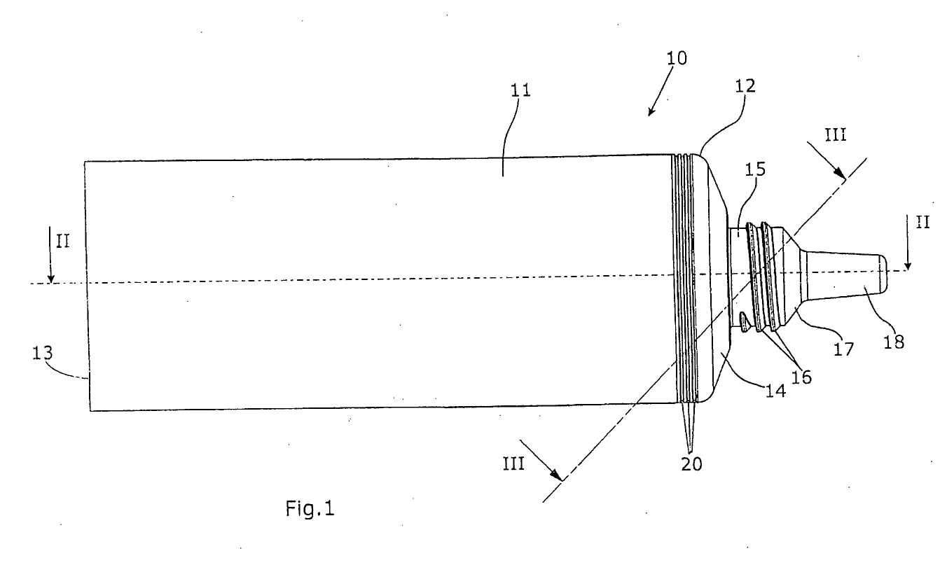

FIG. 1 is a side view of a unfinished tube.

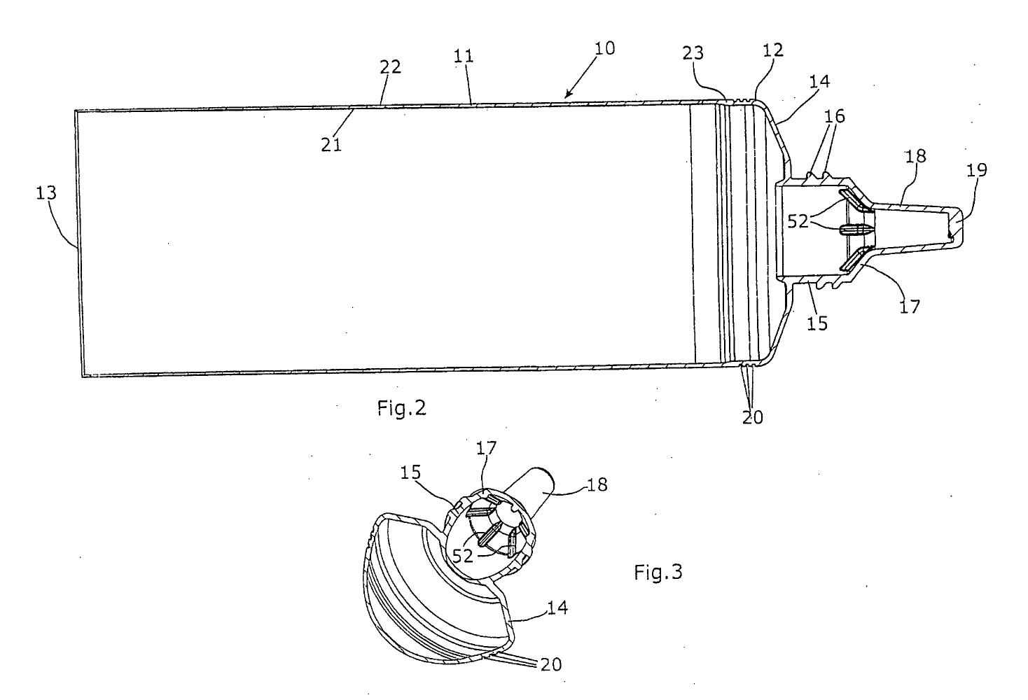

FIG. 2 is a longitudinal section through the unfinished tube.

FIG. 3 is a section along line III-III in FIG. 1.

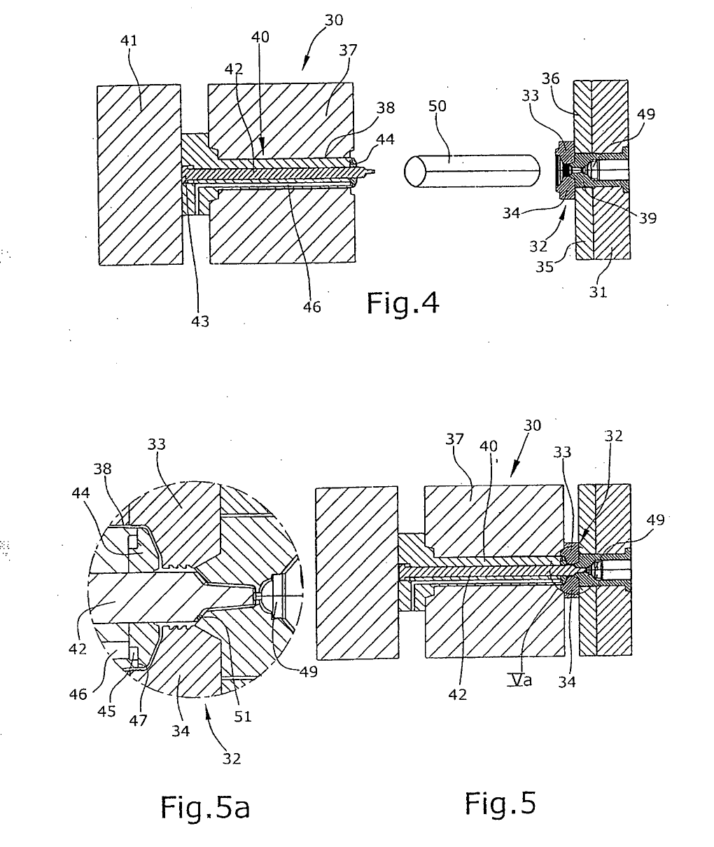

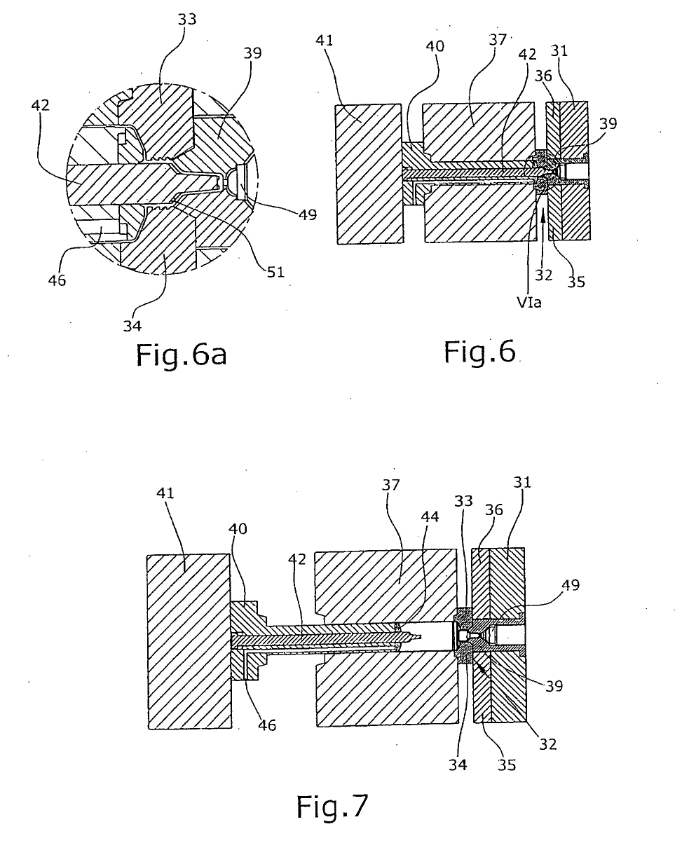

FIGS. 4-10 illustrate different stages of the injection molding operation for producing the unfinished tube, with FIGS. 5a and 6a showing enlarged detail views of the encircled areas in FIGS. 5 and 6.

FIG. 11 is a longitudinal section through another embodiment of the injection mold, and

FIG. 11a is an enlarged representation of the area encircled in FIG. 11.

The unfinished tube 10 illustrated in FIGS. 1-3 has a generally cylindrical tube body 11 whose front end bears the reference numeral 12, while its open rear end bears the reference numeral 13. The front end 12 is adjoined by the frustoconical tube shoulder 14. A thread portion 15 projects from the tube shoulder 14, being formed with an outer thread 16. The thread portion 15 passes into a frustoconical transition portion 17 that is adjoined by the tube outlet 18. Here, the tube outlet 18 is illustrated with a closed end wall 19. The same may be cut off or pierced when opening the tube.

In the area of the front end 12, the outside of the tube body 11 is provided with grooves 20 serving to hold the tube body at the neck mold while the core and the female die are withdrawn. If the undercut of the tube shoulder 14 is provided with an outer thread 16 molded thereto or with comparable holding claws, it would be conceivable to hold the front of the unfinished tube 10 in the neck mold without the grooves 20.

As illustrated in FIG. 2, the inner surface 21 and the outer surface 22 are not exactly parallel to each other and they are not exactly cylindrical, either. Rather, the diameter of the inner surface 21 widens from the front end 12 to the rear end 13 and the diameter of the outer surface 22 increases from the rear end 13 to the front end 12. Here, the demolding bevel of the outer surface 22 is larger than that of the inner surface 21.

FIG. 3 illustrates the inner portion of the tube neck with the tube shoulder 14 and the tube outlet 18. The transition portion 17 shows a plurality of small ribs 52 which were used to fill the mold during the injection phase. These ribs 52 could be provided both on the outside and on the inside in the transition portion of the tube.

The unfinished tube 10 is an integral part of a soft elastic plastic material, preferably PE or PP. The rear end 13 of the tube body 11 is flattened and sealed after filling. The material of the unfinished tube is so soft and the wall thickness is so thin that it can be compressed with the fingers of one hand to extrude the tube contents through the tube outlet 18. The material may be of corresponding deformability also in the region of the tube shoulder 14. Only in the region of the thread portion 15 and in the region of the tube outlet 18 is the wall thickness large enough to provide a certain rigidity there. In the region of the grooves 20, the wall thickness is also large enough to provide sufficient dimensional stability for demolding. Adjoining the region of the grooves 20 is a changing portion 23 in which the wall thickness decreases so that the main part of the tube body 11 is easily compressible or flexible. The larger wall thickness in the region of the grooves 20 has the effect that the inner diameter of the tube body is smaller in the region of the grooves 20 than in the main part of the tube body. With rigid cartridges, in which a piston can be displaced, such a change in wall thickness is not possible since the path of the piston would be blocked thereby.

The tube material belongs to the softer product types of PE- or PP-based packaging materials, preferably having an E modulus of less than 750 MPa (750 N/mm²), however, especially having an E modulus of less than 450 MPa (450 N/mm²). The tube body is a compressible body (soft tube or squeeze tube). Depending on the position and the demolding bevel along the length of the tube body, the wall thickness in the main part of the tube body 11 preferably is 0.4 to 0.9 mm.

FIG. 4 illustrates the injection mold 30 for producing the unfinished tube 10. It comprises a substantially plate-shaped neck mold 32, connected with the injection molding machine via a holding plate 31, and two jaws 33, 34 adapted to be displaced relative to each other in a common plane, as well as a centering insert 39. The jaws form that part of the mold cavity that molds the front portion of the unfinished tube. The jaws 33, 34 are fastened to supporting plates 35, 36 and are adapted to be moved outward relative to the neck mold 32. The supporting plates are mounted on the holding plate 31 so as to be axially displaceable. The supporting plates 35, 36 and the holding plate 31 form a passage for an injection nozzle 49 inserted into the centering insert 39, through which nozzle the liquid plastic material is first injected into that part of the mold cavity that will later form the end wall 19 (FIG. 2) i.e. into the front most end of the unfinished tube 10.

The tubular part of the unfinished tube 10 is molded with the female die 37 that forms a substantially cylindrical mold channel which is the outer limit of the mold cavity 38. The core 40 plunges into the rear end of the female die 37, defining the inner limit of the mold cavity 38. The core 40 is mounted to a core holder 41 and includes an inner core 42 in a longitudinal bore, which is movable in the axial direction under control of a piston 43.

The front end of the core 40 is formed by a cap 44 that molds the inner side of the tube shoulder 14. The rear side of the cap 44 defines an annular air channel (FIG. 5a) into which a blow line 46 opens that extends through the core 40. The air channel 45 communicates with the mold cavity 38 through a slot 47. This slot 47 is so narrow that it allows air to pass into the mold cavity 38, yet it cannot be passed by the plastic melt.

FIG. 4 illustrates the state in which the female die 37 and the core 40 are both retracted from the neck mold 32 and the mold is thus opened. The mold cavity 38 accommodates a sheet 50 rolled in a cylinder. The sheet 50 may be a label with a print or a decorative pattern or a texture. It is also possible to use a material with specifically better barrier properties against gases or water vapor than the basic material of the tube. Or the chemical resistance of the sheet or the sliding properties of the surface are specifically adapted to the product or process requirements. The sheet 50 is integrated into the unfinished tube, i.e. plastic material is injected around or behind it and it becomes an integral part of the tube. After the sheet 50 has been inserted into the mold cavity 38, the mold 30 is closed as illustrated in FIG. 5 by moving the female die 37 with the core 40 positioned therein up to the jaws 33, 34 of the neck mold 32.

The inner core 42 extends through the core 40, which inner core is movable in the axial direction relative to the core 40 and protrudes from the front end of the cap 44. The inner core 42 forms the inner side of the tube mouthpiece.

In FIG. 5, the inner core 42 is in its front end position in the first injection phase. According to FIG. 5a, the front end of the inner core 42 that molds the transition portion 17 and the tube outlet 18 (FIGS. 1 and 2), is provided with webs 51 between which passages for the liquid plastic material exist. The webs 51 abut against an inner cone of the associated mould outer wall. In an alternative embodiment, the webs are not formed to the inner core 42 but to the inner cone of the centering insert 39.

In the state illustrated in FIG. 5, liquid plastic material is injected into the injection mold from the injection nozzle 49 in a first injection phase. Here, the jaws 33 and 34 mold the threaded portion 15 and the portion of the tube shoulder 14 including the grooves 20 (FIGS. 1-3).

After termination of the first injection phase, the inner core 42 is retracted so that the webs 51 no longer abut the catching cone of the centering insert 39, but are spaced therefrom as illustrated in FIGS. 6 and 6a. Thus, the portions previously kept free by the webs 51 are closed with plastic melt in a fill-up phase.

In the present injection molding methods, injecting the plastic melt in the process of producing integral tubes is effected at injection pressures far above 1,000 bar, for some materials and tube geometries even above 2,000 bar.

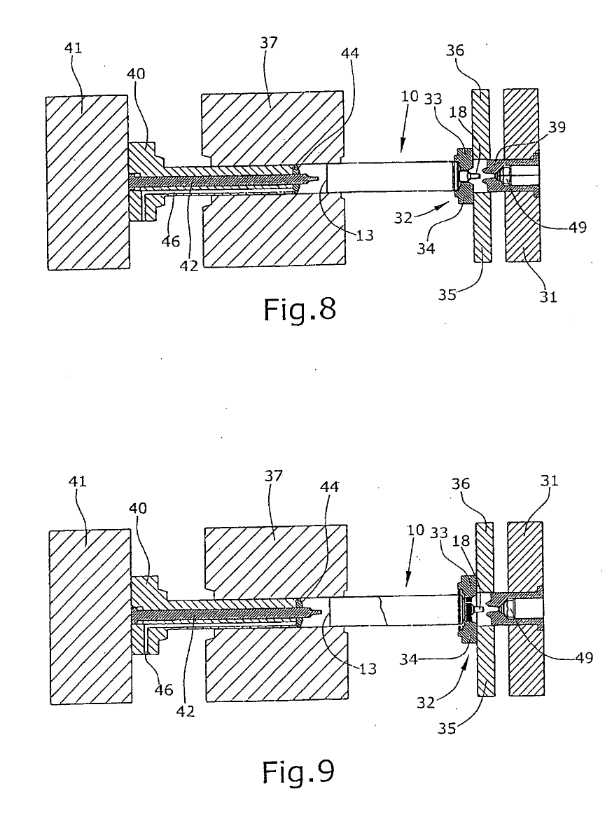

FIG. 7 illustrates a first demolding movement wherein the core 40 is withdrawn from the female die 37. FIG. 8 illustrates how the female die 37 is eventually withdrawn as well. Here, the core 40 has already left the unfinished tube 10, however, the rear end 13 of the unfinished tube is still within the hollow form 37. At the same time, the supporting plates 35, 36, together with the jaws 33, 34, are moved from the holding plate 31 so that the tube outlet 18 of the unfinished tube is released from the centering insert 39. The unfinished tube 10 is retained by the jaws 33, 34 that engage into the grooves 20 and the thread 16.

FIG. 9 illustrates the beginning of the opening of the jaws 33, 34 for releasing the front end of the unfinished tube. The rear end of the same is still partly within the female die 37. By conducting air into the mold cavity, the unfinished tube can be demolded from the rear end 13 an, if it has already been released from the neck mold by opening the jaws.

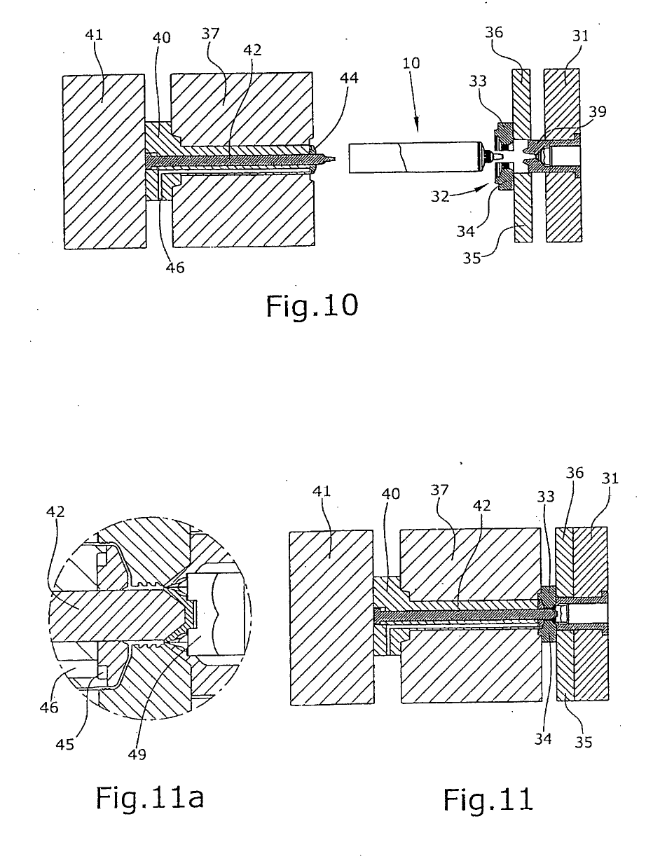

FIG. 10 illustrates the release of the unfinished tube 10 with the core and the female die retracted, the unfinished tube falling from the neck mold by opening the jaws 33, 34.

By supplying air, the tube material is pressed away from the core 40 during the cooling and the demolding. Thereby, adhesion of the plastic material to the core is reduced.

After the unfinished tube has been produced, its rear end 13 is flattened and sealed, thereby finishing the tube. Filling can be accomplished in the open state through the rear end 13 before the flattening and sealing.

In the embodiment of FIGS. 11 and 11a, the tube is injection molded by injecting the plastic material into the region of the tube outlet, the thread portion or, not illustrated, the region of the tube shoulder 14. In any case, injection is made into an open cavity of the tube geometry, without webs being provided to support and center the inner cone 42, and the injection process is performed in one step, i.e. it does not have to be divided into an injection phase and a fill-up phase for filling webs previously held free. In this case, for example, the injection nozzle 49 is an annular nozzle or it preferably consists of a plurality of individual nozzles arranged in a circle.

The wall thickness of the tube is less than 1 mm in the region of the tube body so that the tube can be squeezed.

1. A method for producing a tube with a compressible peripheral wall, wherein:
injection molding of an integral unfinished tube comprising a tube body, a tube shoulder and a tube outlet using a female die, a core and a neck mold;
demolding the unfinished tube by withdrawing the core while retaining the unfinished tube in the neck mold, and withdrawing the female die;
releasing the unfinished tube from the neck mold; and
flattening and closing the open end of the tube body.

2. The method of claim 1, wherein a sheet or a sleeve is placed between the core and the female die and caused to contact the core or the female die.

3. The method of claim 1, wherein a sheet is placed between the core and the neck mold and caused to contact the core or the neck mold.

4. The method of claim 1, wherein air is supplied through a blow line of the core to between the unfinished tube and the core to reduce adhesion to the core.

5. The method of claim 1, wherein a demolding bevel of the female die is made larger than a demolding bevel of the core.

6. The method claim 1, wherein the female die or the core is provided with a slide coating.

7. The method of claim 2, wherein the sheet or the sleeve is made of a material having high resistance against the material to be filled into the tube.

8. The method of claim 2, wherein the sheet or the sleeve is made of a material impermeable to vapor, gas or solvent.

9. The method of claim 2, wherein the sheet or the sleeve comprises a printed label or a decorative sheet.

10. The method of claim 2, wherein the sheet or the sleeve is made from a plastically deformable material that counteracts the restoring property of the soft plastic material.

11. The method claim 1, wherein the core or a part thereof is supported at the neck mold during at least a part of the injection phase.

12. The method of claim 1, wherein in a first injection phase, conically centered webs support the core or a part thereof at the neck mold in a centering portion between the tube shoulder and the tube outlet, and, in a fill-up phase, the core or a part thereof is held spaced from the centering portion to fill the portions held free by the webs during the injection phase.

13. A tube produced according to the method of claim 1, wherein ribs are formed near the tube shoulder.

14. A tube produced according to the method of claim 1, wherein grooves are provided near the tube shoulder to hold the unfinished tube when the injection mold is opened, and that a portion of reduced wall thickness is provided adjoining the grooves.
